(19) United States
(12) Patent Application Publication
(10) Pub. No.: US 2007/0076199 A1
(43) Pub. Date: Apr. 5, 2007

(54) Laser microscope

(75) Inventor: Takahiro Ode, Hyogo (JP)

Correspondence Address: EDWARDS & ANGELL, LLP, P.O. BOX 55874, BOSTON, MA, 02205, US

(73) Assignee: Nanophoton Corp., Osaka City (JP)

(21) Appl. No.: 11/513,866

(22) Filed: Aug. 30, 2006

(30) Foreign Application Priority Data
Aug. 30, 2005 (JP) 2005-249191

(51) Int. Cl. G01J 3/44

(52) U.S. Cl. 356/301

(57) ABSTRACT

A laser microscope according to an embodiment of the invention includes: a laser beam source; a phase plate providing a phase difference for laser beam from the laser beam source in accordance with an incident position; an objective lens focusing light transmitted through the phase plate onto a sample; a first separating unit separating second harmonic light emitted from the sample in a direction opposite to a traveling direction of the laser beams from a fundamental light reflected by the sample; and a photodetector detecting the second harmonic light separated from the fundamental light by the first separating unit.

### BACKGROUND OF THE INVENTION

1. Field of the Invention

The present invention relates to a laser microscope, and more particularly to a laser microscope for detecting second harmonic light generated from a sample.

2. Description of Related Art

As a laser microscope utilizing a laser beam, a variety of microscopes have been developed for many purposes. The laser microscope focuses a laser beam emitted from a laser beam source onto a sample, and receives light reflected by or emitted from the sample to thereby observe and examine the sample.

As an example of the laser microscopes, there has been known a confocal microscope. The confocal microscope has attracted attentions in terms of a high resolution and an ability to acquire three-dimensional information on the sample. Known as an example of such a confocal microscope is a confocal microscope that scans the sample surface with irradiated light through the use of a rotating pinhole substrate (for example, see Japanese Unexamined Patent Application Publication No. 05-127090). The light from a light source enters the rotating pinhole substrate having plural pinholes. The split light from the pinholes moves on the sample. The pinholes are formed in the substrate in accordance with a spiral array at equal pitches in the radial and circumferential directions along spiral track so as to prevent the unevenness of brightness on the sample.

As another example of the confocal microscope, a confocal optical scanner having pinholes arranged at a constant density has been known (for example, see Japanese Unexamined Patent Application Publication No. 05-119262). The pinhole may be a microlens. However, the pinhole substrate having the thus-arranged pinholes is insufficient from the viewpoints of preventing the brightness unevenness and increasing the illumination on the sample in some cases. Further, an effective method of designing such an array substrate has not yet been well discussed.

To give another example of the laser microscope, a second harmonic microscope (SHG microscope) has been put into practical use, which measures various physical characteristics of a sample by use of second harmonic light generated by irradiating the sample with a laser beam (Nanophoton Corp., SHG-11 catalogue). The measurement of the characteristics with the SHG microscope is carried out by focusing a laser beam from a laser beam source onto a sample to scan the sample with the beam to detect second harmonic light emitted from the inside of the sample. The SHG microscope is regarded as being especially effective for detection of a structure or function of cells or protein levels in the medical field or in the field of biotechnology.

The SHG microscope detects second harmonic light emitted from the sample with an emission pattern of FIG. 9. The second harmonic light is emitted in the same direction as a traveling direction of the incident light. Incidentally, in FIG. 9, the arrow direction is the traveling direction of the incident light. In addition, a photodetector is provided on the rear side of the sample to detect the second harmonic light transmitted through the sample.

However, the conventional SHG microscope detects light transmitted through the sample and thus cannot observe light from a sample if the sample is not transparent. Further, it is difficult to observe light from a sample if the sample is thick like a living body.

As described above, in the conventional SHG microscope, the second harmonic light is emitted in the same direction as the incident light-traveling direction, so only second harmonic light transmitted through a sample can be detected.

### SUMMARY OF THE INVENTION

The present invention has been completed in view of the aforementioned problems, and it is accordingly an object of the invention to provide a laser microscope capable of detecting second harmonic light emitted in an opposite direction to a traveling direction of incident light.

A laser microscope according to an aspect of the invention includes: a laser beam source(for example, a laser beam source 10 of embodiments of the invention); a phase plate (for example, a phase plate 12 of embodiments of the invention) providing a phase difference for laser beam from the laser beam source in accordance with an incident position; an objective lens (for example, an objective lens 16 of embodiments of the invention) focusing light transmitted through the phase plate onto a sample; a first separating unit (for example, a fundamental light cut filter 22 of embodiments of the invention) separating second harmonic light emitted from the sample in a direction opposite to a traveling direction of the laser beam from a fundamental light reflected by the sample; and a photodetector (for example, a photodetector 19 of embodiments of the invention) detecting the second harmonic light separated from the fundamental light by the first separating unit. Hence, it is possible to detect second harmonic light emitted in the direction opposite to a laser beam traveling direction.

According to a second aspect of the invention, in the laser microscope of the first aspect, the phase plate preferably provides a phase difference of 180° for the laser beam in areas opposite to each other across an optical axis. Hence, an amount of second harmonic light emitted backward can be increased.

According to a third aspect of the invention, in the laser microscope of the first aspect, the phase plate includes ½ wavelength plates optical axes of which are shifted from each other by 90°, in areas opposite to each other across an optical axis. Hence, an intensity of second harmonic light emitted backward can be increased.

According to a fourth aspect of the invention, in the laser microscope of the second or third aspect, an oscillation direction of an electric vector of a laser beam in one of the areas opposite to each other across the optical axis is opposite to an oscillation direction in the other area. Hence, an amount of second harmonic light emitted backward can be increased.

According to a fifth aspect of the invention, the laser microscope of any one of the first to fourth aspects further includes: a second separating unit (for example, a fundamental light cut filter 21 of embodiments of the invention) for separating second harmonic light emitted from the sample in the same direction as the traveling direction of the laser beam from a fundamental light transmitted through the sample; and a photodetector (for example, a photodetector 18 of embodiments of the invention) detecting second harmonic light emitted from the light source in the same direction as a traveling direction of light, wherein the phase plate can be inserted/retracted to/from an optical path. Hence, it is possible to detect the second harmonic light emitted forward and backward.

According to the present invention, it is possible to provide a laser microscope capable of detecting second harmonic light emitted in an opposite direction to a traveling direction of incident light.

### BRIEF DESCRIPTION OF THE DRAWINGS

The above and other objects, advantages and features of the present invention will be more apparent from the following description taken in conjunction with the accompanying drawings, in which:

FIG. 1 shows a structure of an SHG microscope according to a first embodiment of the present invention;

FIGS. 2A and 2B show a structure of a phase plate in the SHG microscope of the first embodiment;

FIG. 3 schematically shows how an oscillating direction of an electric vector varies depending on a phase plate;

FIG. 4 shows a second harmonic light emission pattern in the SHG microscope of the embodiment;

FIG. 5 shows another structure of the phase plate in the SHG microscope of the first embodiment;

FIG. 6 shows another structure of the phase plate in the SHG microscope of the first embodiment;

FIG. 7 shows a structure of an SHG microscope according to a second embodiment of the present invention;

FIG. 8 shows a structure of an SHG microscope according to a third embodiment of the present invention; and

FIG. 9 shows a second harmonic light emission pattern of a conventional SHG microscope.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Incidentally, the same components are denoted by identical reference numerals throughout the accompanying drawings, and description thereof is omitted if not necessary.

### First Embodiment

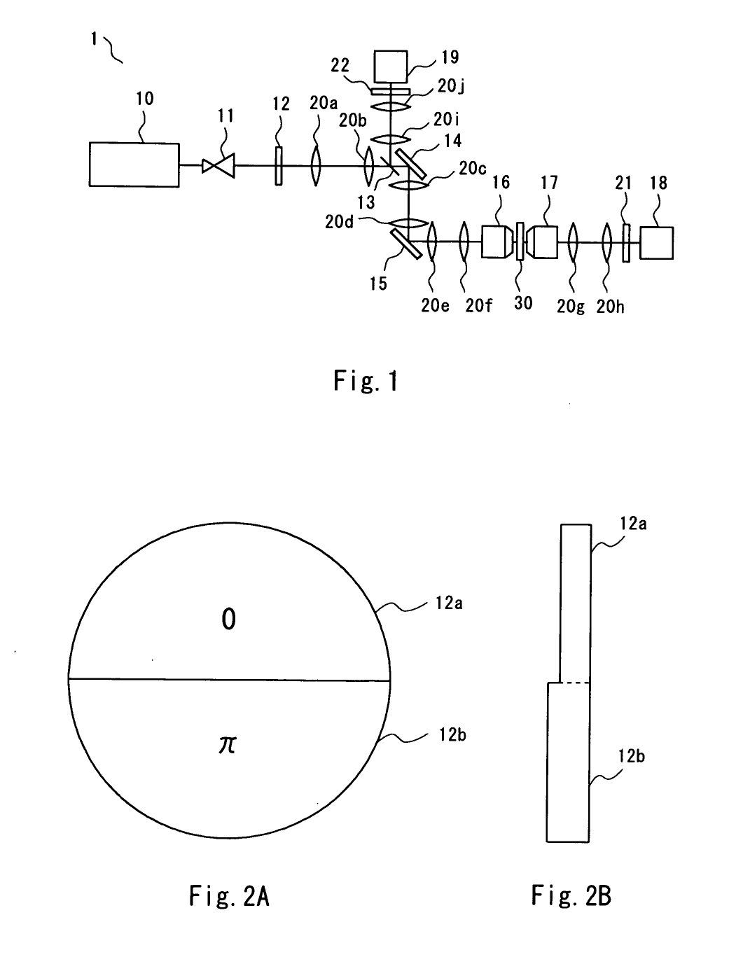

Referring to FIG. 1, description is given of a SHG microscope according to a first embodiment of the present invention. FIG. 1 is a diagram schematically showing the SHG microscope of this embodiment. The SHG microscope is an optical microscope that irradiates a sample with light of a predetermined wavelength and utilizes second harmonic generation(SHG). The SHG microscope can be utilized for observation of various samples such as a catalytic-reaction surface or microstructure of metal or a semiconductor. This microscope is especially effective for detection of a structure or function of cells or protein levels in the medical field or in the field of biotechnology. An image of second harmonic light (an image of a light intensity profile of the second harmonic light) represents an orientation distribution of molecules or the like. Based on the image, the unevenness in molecular density due to a non-equilibrium phenomenon or a distribution pattern of oriented molecules can be checked. A living body sample is constituted of asymmetric biomolecules, and a second harmonic light image thereof is effective for extraction and observation of a special structure in the living body. In most cases, multiphoton-excited fluorescence is emitted from a sample along with the emission of second harmonic light. An SHG microscope 1 of this embodiment can observe the multiphoton-excited fluorescence as well as the second harmonic light generated from the sample at the same time. The multiphoton-excited fluorescence means excited fluorescence caused by absorbing two or more photons at the same time.

In FIG. 1, reference numeral 10 denotes a laser beam source; 11, a beam expander; 12, a phase plate; 13, a beam splitter; 14, a galvanometer mirror; 15, a galvanometer mirror; 16, an objective lens provided on the light incidence side; 17, an objective lens provided on the light transmission side; 18, a photodetector for detecting second harmonic light that propagates in the same direction as a traveling direction of incident light; 19, a photodetector for detecting second harmonic light that propagates in an opposite direction to a traveling direction of incident light; 20, lenses; 21, a transmission-side fundamental light cut filter; 22, a reflection-side fundamental light cut filter; and 30, a sample.

In the SHG microscope structured as shown in FIG. 1, the photodetector 18 detects second harmonic light generated from the sample 30 and propagating forward, and the photodetector 19 detects second harmonic light generated from the sample 30 and propagating backward. Here, the term “forward” implies the same direction as a propagating direction of incident light, and the term “backward” implies a direction opposite to the propagating direction of incident light.

As the laser beam source 10 of this embodiment, a laser device capable of emitting second harmonic light and multiphoton-excited fluorescence is used. For example, at the time of observing living cells, an infrared light pulse laser device such a mode-locked titanium sapphire laser device may be used as the laser beam source 10, for example. Laser light characteristics such as a laser-light wavelength, a laser light intensity, an oscillation mode, a repetition frequency, and a pulse width are appropriately selected in accordance with a sample type or an observation method.

The beam expander 11 expands a beam diameter of light from the laser beam source 10 to emit the expanded beam. The expanded beam from the beam expander 11 enters the phase plate 12. In the case of detecting second harmonic light generated from the sample 30 and propagating backward, the phase plate 12 is placed in an optical path. In the case of detecting second harmonic light emitted from the sample 30 and propagating forward, the phase plate 12 is retracted from the optical path. The phase plate 12 is described below in detail. The light emitted from the phase plate 12 is refracted by the lenses 20a and 20b to enter the beam splitter 13. A part of the light incident on the beam splitter 13 passes through the beam splitter 13 and enters the galvanometer mirror 14.

The light reflected by the galvanometer mirror 14 is refracted by the lenses 20c and 20d to enter the galvanometer mirror 15. The galvanometer mirror 14 and the galvanometer mirror 15 scan a beam to enable imaging and observation of the entire surface of the sample. The light reflected by the galvanometer mirror 15 is refracted by the lenses 20e and 20f to enter the incidence-side objective lens 16. The objective lens 16 focuses the incident laser beam, and the focused beam enters the sample 30.

The sample 30 receives the incident light to emit multiphoton-excited fluorescence and second harmonic light having a frequency twice as high as the incident light. A typical multiphoton-excited fluorescence is a two-photon excited fluorescence. The second harmonic light and the multiphoton-excited fluorescence that are emitted from sample 30 and propagating forward partially transmit the sample 30. The second harmonic light and multiphoton-excited fluorescence transmitted the sample 30 are condensed by the transmission-side objective lens 17.

Further, the fundamental light transmitted through the sample 30 is also collected by the transmission-side objective lens 17. The transmission-side objective lens 17 and the incidence-side objective lens 16 are provided on opposite sides of the sample 30. The sample 30 is placed between the incidence-side objective lens 16 and the transmission-side objective lens 17. Preferably, the two objective lenses 16 and 17 can focus beams at substantially the same focal point on the sample.

The light from the objective lens 17 is refracted by the lenses 20g and 20h, and the refracted light enters the fundamental light cut filter 21. The fundamental light cut filter 21 separates the second harmonic light from the fundamental light and the multiphoton-excited fluorescence. That is, only the second harmonic light out of the light emitted from the objective lens 17 and incident to the fundamental light cut filter 21 passes through the fundamental light cut filter 21. The fundamental light cut filter 21 may be, for example, a band-pass filter or short wavelength pass filter that shields light having a wavelength region of output light from the laser beam source 10 and light having a wavelength region of multiphoton-excited fluorescence. Alternatively, the fundamental light cut filter 21 may be a dichroic mirror provided diagonally to an optical axis. If the fundamental light cut filter 21 is changed to a band-pass filter that shields light having a second harmonic light wavelength region and light having a wavelength region of the fundamental light, the multiphoton-excited fluorescence can be detected.

The second harmonic light transmitted through the fundamental light cut filter 21 enters the photodetector 18. The light incident on the photodetector 18 is focused by the lens 20h or the like to enter a light receiving surface of the photodetector 18. The photodetector 18 is, for example, a two-dimensional photosensor such as a CCD camera. It is preferred to provide the photodetector 18 with an image intensifier to effectively detect the second harmonic light as faint light. The photodetector 18 detects the incident light to convert the light into a video signal. The video signal is input to an image processor (not shown) for processing an image, Hand a taken image is displayed on a display.

Meanwhile, the second harmonic light emitted from the sample 30 toward a direction opposite to the propagating direction of incident light travels in the direction opposite to the propagating direction of incident light. That is, the second harmonic light emitted backward enters the objective lens 16 and travel towards the laser beam source 10. The second harmonic light is refracted by the objective lens 16, and the lenses 20f and 20e to enter the galvanometer mirror 15. The second harmonic light reflected by the galvanometer mirror 15 is refracted by the lenses 20d and 20c to enter the galvanometer mirror 14. The second harmonic light reflected by the galvanometer mirror 14 enters the beam splitter 13. The beam splitter 13 reflects a part of the incident light toward the photodetector 19. The light reflected by the beam splitter 13 is refracted by the lenses 20i and 20j to enter the fundamental light cut filter 22. The fundamental light cut filter 22 separates only the second harmonic light from the multiphoton-excited fluorescence and the fundamental light that propagates in the same direction as the second harmonic light. That is, only the second harmonic light out of the light incident from the objective lens 16 onto the fundamental light cut filter 22 passes through the fundamental light cut filter 22. The fundamental light cut filter 22 may be structured similar to the transmission-side fundamental light cut filter 21.

Then, the second harmonic light transmitted through the fundamental light cut filter 21 enters the photodetector 19. The light incident on the photodetector 19 is focused by the lens 20j or the like to enter the light receiving surface of the photodetector 19. The photodetector 19 is, for example, a two-dimensional sensor such as a CCD camera. It is preferred to provide the photodetector 19 with an image intensifier to effectively detect the second harmonic light as faint light. The photodetector 19 detects the incident light to convert the light into a video signal. The video signal is input to an image processor (not shown) for processing an image, and a taken image is displayed on a display.

Referring next to FIGS. 2A and 2B, the phase plate 12 is described. FIG. 2A is a plan view schematically showing the structure of the phase plate 12, and FIG. 2B is a sectional view schematically showing the structure of the phase plate 12. As shown in FIG. 2A, the phase plate 12 has a disk-like shape, and its thickness is different from an upper area 12a and a lower area 12b across the center line. That is, the phase plate 12 is a disk the thickness of which is changed at the center line. The phase plate 12 is placed vertically to the optical axis, so each of the upper area 12a and the lower area 12b is placed vertically to the optical axis. The center of the phase plate 12 is aligned with the optical axis. The phase plate 12 is, for example, a transparent glass plate that transmits a laser beam.

The laser beam incident on the phase plate 12 is emitted with a phase difference in accordance with the thickness difference. In this example, a phase difference between the laser beam from the upper area 12a and that from the lower area 12b is 180°. That is, the thickness difference between the upper area 12a and the lower area 12b of the phase plate 12 is set to an optical distance that is half the wavelength of laser beam. Accordingly, the laser beam transmitted through the phase plate 12 involves a spatial phase difference; the phase difference between the upper half and the lower half is 180°. That is, the phase plate 12 provides a phase difference for the laser beam in accordance with incident positions. Incidentally, in the above description, the thickness of the phase plate 12 is non-uniform, but a transmissive film may be formed on a flat transparent plate.

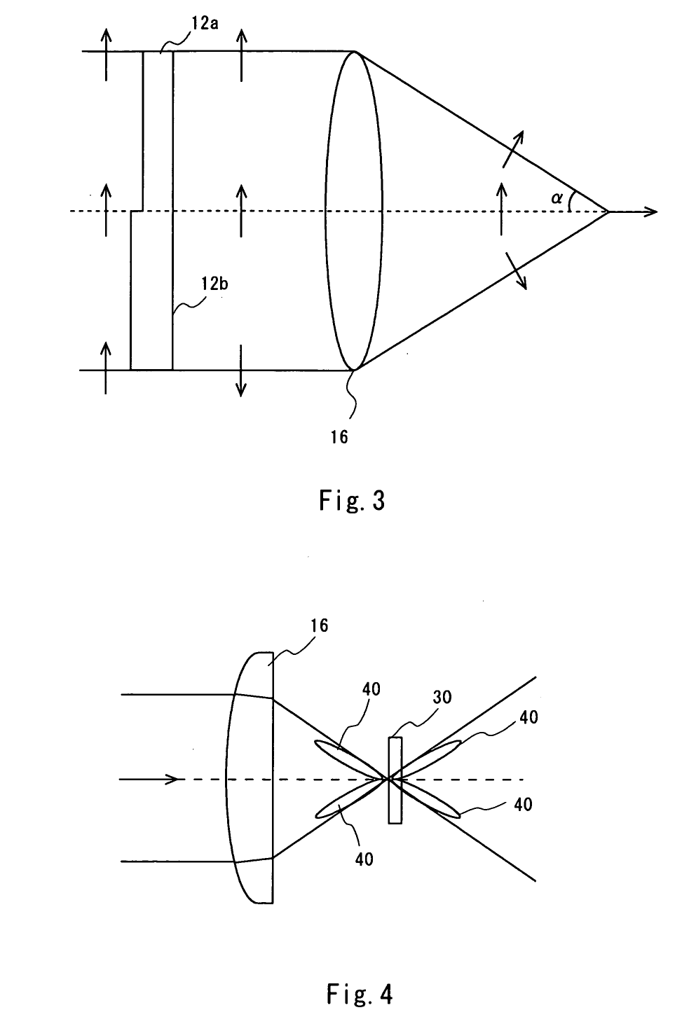

If the phase plate 12 is placed in the optical path, the second harmonic light from the sample 30 is emitted backward. A mechanism of emitting the second harmonic light backward is described below. First, an effect of arranging the phase plate 12 in the optical path is described with reference to FIG. 3. FIG. 3 schematically shows how the light is propagating from the phase plate 12 to the sample 30 for the purpose of explaining the principle for emitting the second harmonic light backward. Incidentally, components between the phase plate 12 and the objective lens 16 are omitted from FIG. 3.

If the phase plate 12 as shown in FIGS. 2A and 2B is placed in the optical path, a phase difference is caused between the light transmitted through the upper area 12a and the light transmitted through the lower area 12b. That is, the light from the upper half is 180° out of phase with the light from the lower half. Assuming that linearly-polarized light is output from the laser beam source 10, components vertical to the electric vector are in phase. The phase plate 12 produces a phase difference of 180° between the electric vectors from the upper area 12a and the lower area 12b. That is, the electric vector of light from the upper area 12a oscillates in the opposite direction to the electric vector light from the lower area 12b. The polarization direction in the upper area 12a is opposite to the polarization direction in the lower area 12b. That is, the light transmitted through the upper area 12a and the light transmitted through the lower area 12b are linearly-polarized lights that are on the same straight line but are opposite in the oscillation direction.

The arrow of FIG. 3 two-dimensionally indicates the oscillation direction of the electric vector in that position. As described above, the laser light is linearly-polarized light before passing through the phase plate 12, so all the electric vectors oscillate in the same direction. Then, the light is transmitted through the phase plate 12, and the oscillation direction is changed in accordance with an incidence position on the phase plate 12. For example, the electric vector of the light transmitted through the upper area 12a oscillates upwardly. On the other hand, the electric vector of the light transmitted through the lower area 12b oscillates downwardly. Incidentally, the oscillation direction of the light passing through the center is an upward direction for ease of illustration in FIG. 3.

Description is made of an example where the light oscillating in such a direction is focused by the objective lens 16. The light transmitted through the upper area 12a is refracted downwardly by the objective lens 16. Accordingly, the oscillation direction of the electric vector of the light extends diagonally upward to the right as shown in FIG. 3. The light transmitted through the center is not refracted by the objective lens 16, so the oscillation direction is kept upward. The light transmitted through the lower area 12b is refracted upwardly by the objective lens 16. Accordingly, the oscillation direction of the electric vector of the light extends diagonally downward to the right. The light beam having different oscillation directions in accordance with the incidence position are focused on the sample 30.

Next, description is given of a state in which the light transmitted through the phase plate 12 is focused on the sample 30 by the objective lens 16. In this example, the oscillation direction of the electric vector of the light is described with regard to two component types: components vertical to the light traveling direction and components parallel to the light traveling direction. Incidentally, in FIG. 3, the oscillation direction of the components vertical to the light traveling direction is assumed as a vertical direction, and the oscillation direction of the components parallel to the light traveling direction is assumed as a horizontal direction.

After the transmission through the objective lens 16, the oscillation direction of the electric vector extends diagonally upward right in the upper area 12a, and the oscillation direction extends diagonally downward right in the lower area 12b. Hence, the components in the vertical direction are opposite to each other. Thus, in such a state that the light is focused on the sample 30, the vertical components in the oscillation direction of the electric vector cancel each other. Accordingly, components of the electric vector vertical to the light traveling direction are reduced to substantially 0. That is, on the sample, the electric vector of the light does not oscillate in the direction vertical to the traveling direction.

The oscillation direction of the electric vector extends diagonally upward right in the upper area 12a and extends diagonally downward right in the lower area 12b. Thus, the horizontal components extend to the right. As a result, the horizontal components of the electric vector in the upper area 12a and the lower area 12b are reinforced with each other. Accordingly, components of the electric vector parallel to the light traveling direction are enhanced to the right. That is, the electric vector of the light oscillates in the direction parallel to the light traveling direction. The objective lens 16 focuses the laser beam that has the phase different after transmitted through the phase plate 12, so the light is irradiated to the sample 30 in such a state that the electric vector oscillates in the direction parallel to the traveling direction.

Next, the light is irradiated to the sample 30 in such a state that the electric vector oscillates in the direction parallel to the traveling direction. The principle for emitting the second harmonic light backward is described with reference to FIGS. 4 and 9. FIG. 4 schematically shows an emission pattern of the second harmonic light when the light enters the sample 30 in such a state that the electric vector oscillates in the direction parallel to the traveling direction. FIG. 9 schematically shows an emission pattern of the second harmonic light when the light enters the sample 30 in such a state that the electric vector oscillates in the direction parallel to the traveling direction. That is, FIG. 4 schematically shows an emission pattern of the second harmonic light in an SHG microscope having the phase plate 12 according to this embodiment. FIG. 9 shows an emission pattern of second harmonic light in a conventional SHG microscope not having the phase plate 12.

First, referring to FIG. 9, the emission pattern of the second harmonic light in the SHG microscope not provided with the phase plate 12 is described. If the phase plate 12 is not provided, the electric vector of the light irradiated to the sample 30 oscillates vertically to the light traveling direction. That is, in the case where the phase plate 12 is not provided, even if the light is focused on the objective lens 16, components parallel to the light traveling direction are cancelled out and reduced to substantially 0. When the light with the electric vector oscillating vertically to the traveling direction is irradiated to the sample 30, polarized molecules oscillate vertically. Thus, an emission pattern 40 of FIG. 9 is obtained, and the second harmonic light is emitted forward. The second harmonic light emitted forward expands with respect to the optical axis in the emission pattern 40. That is, the expanded second harmonic light is emitted in the same direction as the incident direction.

Meanwhile, description is given of the emission pattern of the second harmonic light in the SHG microscope having the phase plate 12 according to this embodiment. In this embodiment, since the phase plate 12 is provided, the electric vector of the light irradiated to the sample 30 oscillates in parallel to the traveling direction. When the light oscillating in parallel to the traveling direction is irradiated to the sample 30, the polarized molecules oscillate laterally. That is, the oscillation direction of the polarized molecules is changed in accordance with the oscillation direction of the electric vector. An emission pattern obtained at this time is inclined with respect to the emission pattern 40 of FIG. 9 by 90°. The emission pattern 40 expands vertically to the traveling direction. As shown in FIG. 4, the second harmonic light is emitted backward. That is, the expanded second harmonic light is emitted in the direction opposite to the incidence direction.

Here, from the viewpoint of increasing a light intensity of the second harmonic light emitted backward, it is preferable to use the objective lens 16 having the large numerical aperture. Thus, an angle at which the light is refracted by the objective lens 16 increases, making it possible to increase components oscillating in the direction parallel to the traveling direction. For example, as shown in FIG. 3, if the angle of the light focused by the objective lens 16 is represented by α, the objective lens 16 that meets “sin α=0.9 to 0.95” is used. Hence, a sufficient intensity of second harmonic light emitted backward can be ensured. Further, in order to obtain a detectable light intensity of second harmonic light by the photodetector 19, it is preferable that sin α≦0.5. That is, provided that α≧30°, the photodetector 19 can detect a light intensity of second harmonic light. Incidentally, the above value of α is set by way of example; the value varies depending on an intensity of light emitted from the laser beam source 11, and performances of an optical system or the photodetector 19.

In this way, the second harmonic light emitted in the direction opposite to the traveling direction of the incident light enters the photodetector 19 by way of the objective lens 16 or the like. Then, an image of the second harmonic light emitted backward is taken by the photodetector 19. Hence, an second harmonic light image can be easily taken in the case of using a non-transparent sample such as a semiconductor or a thick sample such as a living body, and an application range of the SHG microscope can be widened.

Incidentally, the phase plate 12 is structured as shown in FIGS. 2A and 2B to give a phase difference in laser beam between the upper area 12a and the lower area 12b. However, a phase difference can be produced between the upper area 12a and the lower area 12b with other structures. Referring to FIG. 5, description is given about this. FIG. 5 is a plan view showing the phase plate 12 that gives a phase difference with a structure different from that of the phase plate 12 of FIGS. 2A and 2B. The phase plate 12 of FIG. 5 is a disk-like plate. The upper area 12a as one of the two divided areas is provided with a ½ wavelength plate having the optical axis that extends in the arrow direction of FIG. 5. The lower area 12b is provided with a ½ wavelength plate having the optical axis that extends in the arrow direction of FIG. 5. That is, the optical axis of the ½ wavelength plate of the upper area 12a is 90° different from that of the lower area 12b. In the structure of FIG. 5, the two semicircular ½ wavelength plates are bonded such that the optical axis of the upper area 12a extends orthogonally to that of the lower area 12b.

The phase plate 12 structured as shown in FIG. 5 is also placed vertically to the optical axis. Further, the phase plate 12 is placed such that the optical axis is aligned with the center of the phase plate 12. If the optical axis of the ½ wavelength plate is inclined by the angle θ with respect to the polarization plane of the incident light, the polarization plane of the exit light is rotated by only 180°−2θ. If the ½ wavelength plate is rotated by angle β, the polarization plane of the exit light is rotated by 2β. Accordingly, the polarization plane is 180° different between the upper area 12a and the lower area 12b the optical axes of which are inclined with each other by 90°. That is, the oscillation direction of the electric vector of the upper area 12a is opposite to that of the lower area 12b. Thus, the phase plate of FIG. 5 can attain effects similar to the phase plate 12 of FIGS. 2A and 2B. That is, the oscillation direction of the electric vector of the upper area 12a can be made opposite to that of the lower area 12b. Accordingly, a phase difference corresponding to an incidence position can be set to the laser beam. Then, the objective lens 16 condenses the light transmitted through the phase plate 12, with the result that the electric vector oscillates in the direction parallel to the light traveling direction.

As described above, if the phase plate 12 is structured as shown in FIG. 5, the second harmonic light is emitted in the direction opposite to the traveling direction of the incident light. Then, an image of the second harmonic light emitted backward is taken by the photodetector 19. Hence, an the second harmonic light image can be easily taken in the case of using a non-transparent sample such as a semiconductor or a thick sample such as a living body, and an application range of the SHG microscope can be widened.

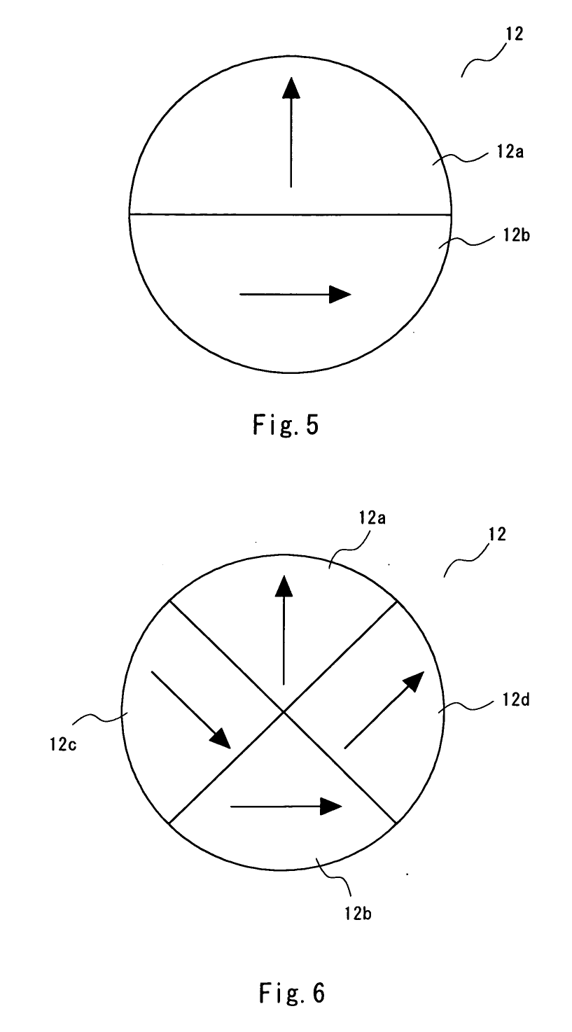

The phase plate 12 of FIGS. 2A and 2B or FIG. 5 gives a phase difference between the two divided areas. However, the phase plate 12 of another structure may be used. For example, the phase plate 12 that gives a phase difference between four divided areas as shown in FIG. 6. In the disk-like phase plate 12 of FIG. 6, the four divided area are provided with ½ wavelength plates different in optical axis. That is, four 90°-fan-like ½ wavelength plates are bonded to constitute the phase plate 12. The optical axis is shifted by 90° between the upper area 12a and the lower area 12b out of the four areas. Further, the optical axis is shifted by 90° between the left area 12c and the right area 12d out of the four areas. That is, the optical axis is shifted by 90° between the ½ wavelength plates opposite to each other across the center line.

If the thus-structured phase plate 12 is used, the oscillation direction of the electric vector is shifted by 180° between the opposite areas. That is, the oscillation direction of the electric vector of the light transmitted through the upper area 12a is opposite to that of the light transmitted through the lower area 12b. Further, the oscillation direction of the electric vector of the light transmitted through the left area 12c is opposite to that of the light transmitted through the right area 12d. The objective lens focuses the light transmitted through the phase plate 12, and thus the electric vector of the incident light oscillates in parallel to the traveling direction on the sample. Hence, the second harmonic light is emitted in the direction opposite to the traveling direction. Then, an image of the second harmonic light emitted backward is taken by the photodetector 19. As a result, an the second harmonic light image can be easily taken in the case of using a non-transparent sample such as a semiconductor or a thick sample such as a living body, and an application range of the SHG microscope can be widened. As described above, the phase plate 12 divided into four areas is used, making it possible to increase components oscillating in parallel to the direction of the electric vector as compared with the phase plate 12 divided into two areas as shown in FIG. 5.

Incidentally, in the illustrated examples of FIGS. 2A and 2B, FIG. 5, and FIG. 6, the phase plate 12 is divided into two or four areas, but the structure of the phase plate 12 is not limited thereto. The phase plate 12 may be divided into plural areas, for example, 8 or 16 areas. For example, if plural fan-like ½ wavelength plates are arranged in the circular shape, a phase difference can be given between opposite areas. In this case, the more divided areas, the larger the components oscillating in parallel to the traveling direction. Further, if the optical axis of the ½ wavelength plate is shifted by 90° between opposite areas across the center, the oscillation directions of the electric vector can be made opposite to each other. Thus, it is possible to increase components oscillating in parallel to the traveling direction of the incident light, and to increase an intensity of second harmonic light emitted backward. Incidentally, as long as the light irradiated to the sample 30 has a sufficient intensity of components oscillating in parallel to the incidence direction, the light may have components oscillating vertically to the incidence direction.

Needless to say, the phase plate 12 is not limited to the above structure, and may be structured insofar as a phase difference corresponding to an incident position can be set to the laser beam to shift the phase of the electric vector. For example, if a liquid crystal optical element is used, the phase of the electric vector can be shifted in accordance with an incident position. Further, the objective lens focuses the beam having the electric vectors out of phase, and thus the electric vector of the incident light has components oscillating in parallel to the traveling direction. Hence, the second harmonic light can be emitted in the direction opposite to the traveling direction of the incident light.

For detecting the second harmonic light emitted forward, the phase plate 12 may be retracted from the optical path. That is, second harmonic light emitted forward or backward can be detected by inserting or retracting the phase plate 12 to/from the optical path.

### Second Embodiment

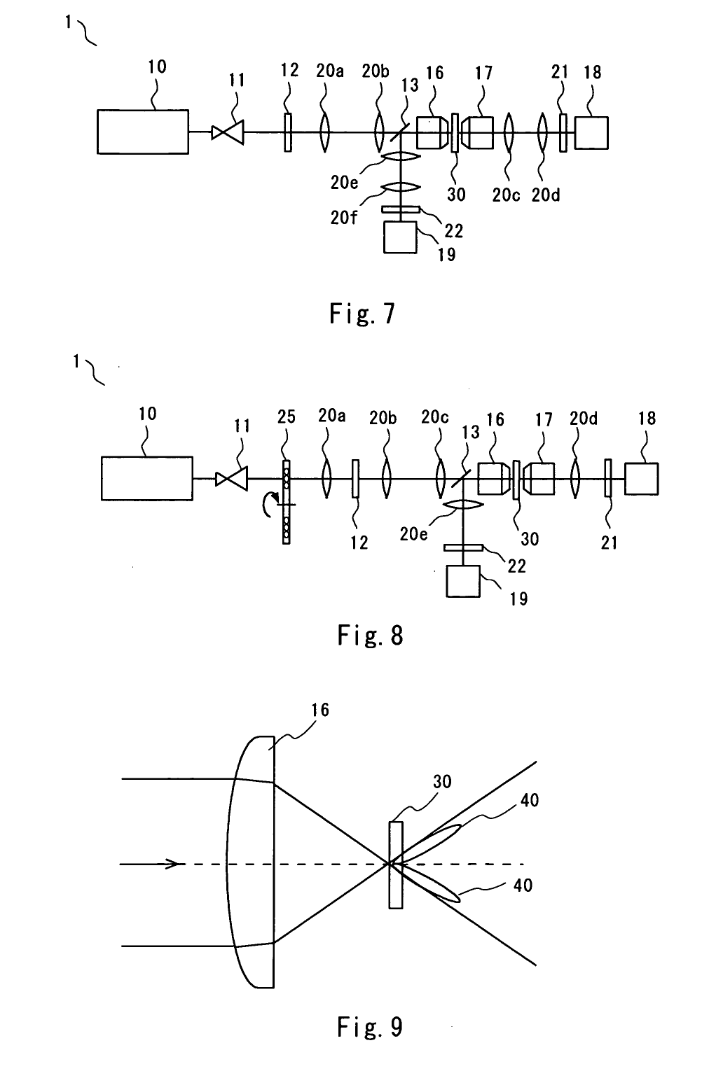

Referring to FIG. 7, an SHG microscope according to a second embodiment of the present invention is described. In this embodiment, a scanning method is different from that of the first embodiment. Although the SHG microscope of the first embodiment scans the laser beam by use of the galvanometer mirror, in this embodiment, the laser beam is scanned by an XY stage. Description about the same components as those of the first embodiment is omitted here.

In this embodiment, a sample 30 is put on the XY stage (not shown). Then, the XY stage is scanned to observe and image the entire surface of the sample. In this SHG microscope as well, if the phase plate 12 of the first embodiment is used, the second harmonic light emitted backward can be detected as in the first embodiment. Thus, similar effects to the first embodiment can be obtained. Further, in this embodiment, the sample is scanned using the XY stage, so an optical system can be simplified.

### Third Embodiment

Referring to FIG. 8, an SHG microscope according to a third embodiment of the present invention is described. A scanning method of this embodiment is different from the first embodiment. Although the SHG microscope of the first embodiment scans the laser beam by means of the galvanometer mirror, in this embodiment, the laser beam is scanned by use of a microlens array disk 25. Description about the same components as those of the first embodiment is omitted here.

In this embodiment, the microlens array disk 25 is interposed between the beam expander 11 and the lens 20a. Further, the phase plate 12 is provided between the lens 20a and the lens 20b. The laser light incident on the microlens array disk 25 is split into plural beams and then enters the lens 20a. The objective lens 16 focuses the incident multi-beam onto the sample. The multi-beam split by the microlens array disk 25 is concentrated to form multi-focal points on the sample 30 due to an image formation function of the objective lens 16. The laser beams move on the sample 30 by the microlens array disk 25 rotating. In this SHG microscope as well, if the phase plate 12 of the first embodiment is used, the second harmonic light emitted backward can be detected as in the first embodiment. Thus, similar effects to the first embodiment can be obtained.

It is apparent that the present invention is not limited to the above embodiment that may be modified and changed without departing from the scope and spirit of the invention.

What is claimed is:

1. A laser microscope, comprising:
a laser beam source;
a phase plate providing a phase difference for laser beam from the laser beam source in accordance with an incident position;
an objective lens focusing light transmitted through the phase plate onto a sample;
a first separating unit separating second harmonic light emitted from the sample in a direction opposite to a traveling direction of the laser beam from a fundamental light reflected by the sample; and
a photodetector detecting the second harmonic light separated from the fundamental light by the first separating unit.

2. The laser microscope according to claim 1, wherein the phase plate provides a phase difference of 180° for the laser beam in areas opposite to each other across an optical axis.

3. The laser microscope according to claim 1, wherein the phase plate includes ½ wavelength plates optical axes of which are shifted from each other by 90°, in areas opposite to each other across an optical axis.

4. The laser microscope according to claim 2, wherein an oscillation direction of an electric vector of a laser beam in one of the areas opposite to each other across the optical axis is opposite to an oscillation direction in the other area.

5. The laser microscope according to claim 3, wherein an oscillation direction of an electric vector of a laser beam in one of the areas opposite to each other across the optical axis is opposite to an oscillation direction in the other area.

6. The laser microscope according to claim 1, further comprising:
a second separating unit for separating second harmonic light emitted from the sample in the same direction as the traveling direction of the laser beam from a fundamental light transmitted through the sample; and
a photodetector detecting second harmonic light emitted from the light source in the same direction as a traveling direction of light,
wherein the phase plate can be inserted/retracted to/from an optical path.

7. The laser microscope according to claim 2, further comprising:
a second separating unit for separating second harmonic light emitted from the sample in the same direction as the traveling direction of the laser beam from a fundamental light transmitted through the sample; and
a photodetector detecting second harmonic light emitted from the light source in the same direction as a traveling direction of light,
wherein the phase plate can be inserted/retracted to/from an optical path.

8. The laser microscope according to claim 3, further comprising:
a second separating unit for separating second harmonic light emitted from the sample in the same direction as the traveling direction of the laser beam from a fundamental light transmitted through the sample; and
a photodetector detecting second harmonic light emitted from the light source in the same direction as a traveling direction of light,
wherein the phase plate can be inserted/retracted to/from an optical path.

9. The laser microscope according to claim 4, further comprising:
a second separating unit for separating second harmonic light emitted from the sample in the same direction as the traveling direction of the laser beam from a fundamental light transmitted through the sample; and
a photodetector detecting second harmonic light emitted from the light source in the same direction as a traveling direction of light,
wherein the phase plate can be inserted/retracted to/from an optical path.

10. The laser microscope according to claim 5, further comprising:
a second separating unit for separating second harmonic light emitted from the sample in the same direction as the traveling direction of the laser beam from a fundamental light transmitted through the sample; and
a photodetector detecting second harmonic light emitted from the light source in the same direction as a traveling direction of light,
wherein the phase plate can be inserted/retracted to/from an optical path.
